(19) United States
(12) Patent Application Publication
(10) Pub. No.: US 2003/0130958 A1
(43) Pub. Date: Jul. 10, 2003

(54) Electronic transactions and payments system

(76) Inventors: Shankar Narayanan, Singapore (SG); Navtej Singh, Singapore (SG); Vishnuram Swaminathan, Singapore (SG)

Correspondence Address: WILLIAM COLLARD, COLLARD & ROE, P.C., 1077 NORTHERN BOULEVARD, ROSLYN, NY, 11576, US

(21) Appl. No.: 10/181,165

(22) PCT Filed: Jan. 18, 2001
(86) PCT No.: PCT/SG01/00007

(30) Foreign Application Priority Data
Jan. 18, 2000 (SG) 200000291.5

(51) Int. Cl. G06F 17/60

(52) U.S. Cl. 705/73

(57) ABSTRACT

Secure electronic transaction system is provided between a plurality of computer systems and other electronic terminals wholly or partly over a public communication system such as the internet, a closed communication system such as a banking network or point-to-point communications such as dial-up connections and leased lines. Secure transmission of transaction information instructions and payment instructions is provided from a customer's computer system to the customer's bank's computer system. The bank's computer system processes and evaluates the instructions and transmits by way of secure transmissions the transaction instructions and payment instructions to the merchant's computer system.

### FIELD OF THE INVENTION

The present invention relates to a system for electronic transactions between two parties and payment for goods and services purchased over a communication network and more specifically, though not exclusively, to a system and method for transmitting both transaction instructions and payment instructions from a customer to a merchant and returning secure authorisation to the merchant and the customer.

### DEFINITIONS

Throughout this specification or reference to a person is to be taken as including a reference to a number of persons whether incorporated or not.

Throughout this specification reference to a computer is to be taken as including a reference to a personal digital assistant, notebook computer, laptop computer, WAP-enabled telephones, and Internet-enabled telephones.

Throughout this specification, the use of product in relation to a merchant is to be taken as including good(s) and/or service(s).

Throughout this specification reference to a bank is to be taken as including a reference to any bank, financial service provider, lending organisation, insurance company, or any other organisation or business having an established distibution channel which includes consumers and or merchants. This includes, but is not limited to, telecommunications service providers, Internet service providers, government departments and organisations, Internet portal operators, petrochemical companies, petroleum companies, retail outlet chains including conveniences stores, and so forth

### BACKGROUND OF THE INVENTION

One of the primary reasons that Internet transactions have not taken off in the way experts predicted (and online sellers would have liked) is the reluctance of many buyers to reveal their account information over the Internet. There is a fear that anything submitted over the Internet can be compromised if a third party gains access to it by intercepting the electronically submitted information. In such a scenario, customers are not comfortable with revealing sensitive information (such as credit/debit card numbers, account numbers pin numbers and passwords) to third parties.

This problem can be circumvented if the seller/service provider can tie up with the customer's bank, so that the customer can directly submit the information to their own bank, thus reducing the risk of the information falling into the wrong hands. Typically, online service providers would sign up with one bank (“merchant's bank”) whereas the customer would have an account with another bank (“customer's bank”). It is difficult for merchants to sign up with and provide a link to all banks possible, and for banks to have their presence on all online shopping/service provider sites. There is a pressing need to enable online service providers to be able to link with all banks.

It is also desirable for a computer operated by a merchant that offers goods and services for sale over a publicly accessible packet-switched network such as the Internet to be able to confirm that the order was made by the customer who is identified in the transaction instruction as the customer, and that the payment instruction is from the customer.

It is also desirable that:

(i) the customer has the means to effect payment;

(ii) the merchant has the assurance that the customer has such means to effect payment; and

(iii) confirmation of authorization for payment be made by a payment system. Such a system is preferably operated by a bank or other financial institution that has the legal and contractual responsibility for providing payment on behalf of the customer, and to authorize the commercial transaction on behalf of the customer.

It is further desirable that where the transaction instruction and the payment instruction are being transmitted over any communication channel, information about the customer's transaction instruction and payment instruction is kept secure. Only the relevant information should be provided to the merchant for processing the transaction. The risk of exposing sensitive information such as credit card and debit card numbers to interception by third parties, and for false authorization of payment to be effected, should be minimized.

Various attempts at achieving these desired objectives have been devised. For example; see http://medoc.informatik.tu-muenchen.de/Chablis/MStudy/. One such attempt is to provide a secure transmission channel for transmission of payment information such as Secure Electronic Transaction (“SET”), jointly developed by the Visa and MasterCard card associations, and described in Visa and MasterCard's Secure Electronic Transaction (SET) Specification, Feb. 23, 1996; hereby incorporated by reference.

Other similar payment technologies include Secure Electronic Payments Protocol (“SEPP”), Internet Keyed Payments (“IKP”), Net Trust, and Cybercash Credit Payment Protocol. Any of the known secure payment technologies can be substituted for the SET protocol without undue experimentation.

Such secure payment technologies require the customer to operate software that is compliant with the secure payment technology. A drawback to the secure payment technology is that its deployment cost is very high. It requires the deployment of special purpose hardware and software by the customer, the merchant, and the bank or other financial institution. In particular, the use of cross-country certification authorities requires substantial investment in infrastructure, as well as co-ordination between the various certification authorities including for example, cross-certification mechanisms, and implementation of certification authority root digital certificates.

Such an infrastructure also requires the implementation of various redundant payment gateways to process payment instructions, which further increases costs and adds to the complexity of the entire system.

Another attempt made was to provide a general secure transmission channel for transmission of information in general. An instance of such an attempt is Netscape Inc's Secure Sockets Layer (Protocol “SSL”). The SSL Protocol version 3.0, March 1996, is hereby incorporated by reference. SSL provides a means for secure transmission between two computers. Other similar technologies include Private Communications Technology (“PCT”) from Microsoft, Secure Hyper-Text Transport Protocol (““SHTT”P”) from Theresa Systems. These have the advantage that they not require the customer to install special software as such technology is already incorporated into the software used by the customer. For example, the Microsoft Internet Explorer, and the Netscape Navigator, browsing tools. SSL is designed primarily for two computer communications, and it does not provide a mechanism for transmitting different types of encoded information to a merchant and to a payment gateway to minimize the risk of exposing sensitive information (such as credit card and debit card numbers) to the merchant, and to minimize abuse of that information if intercepted, by third parties. More importantly, the above technologies involving the use of secure transmission channels do not inhibit, stop or reduce the incidence of electronic commerce fraud. A very large proportion of electronic commerce conducted over the Internet today is conducted through the use of credit cards. Credit card information is transmitted over the Internet to the merchant's computer from the customer's computer through public communication channels. While security in transmission channels such as SET and SSL will minimize incidents of unauthorized third party interception of credit card information, these security measures are no assurance that the merchants' computers themselves are secure from unauthorized third party access, or even from unauthorized access by rogue employees operating the merchants' computers. Merchants' computers are targets for unauthorized access by hackers because they contain records of many transactions, and credit card numbers from authentic cardholders will comprise part of the information stored.

Once unauthorized access is achieved, access can be obtained to many of these credit card numbers. Fraudulent transactions can then be conducted without the knowledge of the credit card holder (or the merchant) both of whom are innocent parties.

For example, it was reported in internetnew.com on Jan. 12, 2000 that in December 1999 a Russian hacker stole 300,000 credit card numbers from the electronic commerce retailer Cduniverse, and dispensed them for free to visitors to his website.

A merchant who is provided a credit card number has to accept it and complete the transaction if the credit card network provides an approval code. An approval code will be given if the card is not reported lost or stolen, and there is sufficient credit. The credit card holder will not know of such a fraudulent transaction and be aware that something is amiss unless and until they receive their monthly statement. For the same reason, the banks detected that issued the credit cards, and made payments to the merchants, will not detected fraud. VISA reports that roughly 8 cents of every US$100.00 spent on line is lost to fraud.

While this percentage may seem small, in the context of the business-to-consumer electronic commerce market that was estimated to worth about US$7 billion in 1998, these losses can be substantial. Such losses will ultimately have to be borne by the customer and the merchant.

It is no surprise that this has given rise to consumer mistrust in electronic commerce. A survey by Visa revealed that currently only 5% of consumers trust electronic commerce on the Internet as opposed to 60% who trust telephone banking. And surveys have shown that the biggest concern of consumers is the transmission of their credit card numbers on the Internet. Unfortunately, the transmission of such information is prescribed by the secure transmission payment and communication technologies such as SET and SSL described above. Neither is digital cash a viable solution. Digital cash gives merchants the immediate assurance of payment for all transactions. This is a disadvantage because of consumer perceptions that these could be instruments of fraud in the electronic environment. As a result, many digital cash implementations restrict the maximum value of the transaction traded using digital cash. This restricts the acceptance of digital cash by merchants. Also, digital cash has not received widespread acceptance, and there are issues of controls over national currencies, currency denominations, and currency exchange controls that further hinder the acceptance of digital cash.

The development of electronic commerce is at a critical juncture. Consumer demand for secure but convenient access to electronic shopping and other services is very high. Electronic commerce merchants want simple, cost-effective methods for conducting electronic transactions, and financial institutions want a level playing field to be able to make available their existing banking and finance infrastructure to both consumers and merchants.

The next step towards achieving secure, cost-effective, on-line transactions to satisfy market demand for such technologies is the development of a single, open, industry standard secure electronic transaction system that takes all these concerns into account, and leverages on existing banking and finance infrastructure.

There are number of variants of the present system:

1. The customer enters their credit card number at the merchant's site. The merchant then contacts the issuing bank with the customer's credit card information and the bank debits the customer's credit card account. The problems associated with such a system are:

the customer gives their credit card number at the merchant's site. This is not a safe transaction from the customer's point of view. The merchant can easily view the customer's credit card information and use it.

the identity of the customer is not established and/or authenticated, leading to insecurity and losses due to fraud.

2. During the time of payment, the customer is redirected to the bank's site and enters their his credit card number at the bank's site. This has the problem that each bank has to separately tie-up with each merchant. This is not feasible because each merchant would already have a tie-up with a particular bank and hence would be reluctant to tie-up with another bank. Also the cost would outweigh the advantages. With a large number of banks issuing credit cards, this would create significant logistical problems.

3. There are other variants of the current system in which the customer goes to the bank's site and enters their debit card information, and provides their pin number. This suffers from the same drawback as the second system, i.e. reluctance of merchants to tie up with more than one bank, and the reluctant logistical problems.

All of the three systems described above also have common drawbacks:

there is no single interface for credit card holders and debit card holders;

customers of banks that do not support Internet banking cannot purchase online; and

customers cannot use their checking accounts for payment.

### OBJECTS OF THE INVENTION

It is a principal object of the present invention to provide an electronic transaction and payment system that provides confidentiality of payment information by separating the transaction information from the payment information.

A further object is to provide a system for electronic payment wherein important payment information such as credit and debit card numbers are not passed across an open network, or to the merchant, but is only received and held by a bank.

Yet another object is to provide a system for electronic payment wherein the merchant is provided a means by which the merchant can have the assurance and confidence that they are dealing with a customer who is a legitimate user of a payment card.

A further object of the present invention is to provide a system for electronic payment wherein the merchant can receive confirmation from the customer, a bank, or a financial institution, that the customer has the means to pay for the transaction.

A final object of the present invention is to provide a system for electronic payment between two persons.

### SUMMARY OF THE INVENTION

With the above and other objects in mind, the present invention provides a method for conducting an electronic transaction between a first person having a first's computer and a second person having a second computer, the first and second computers being able to be connected to each other by at least one communication network; the method including the steps of:

(a) establishing a communication between the first computer and the second computer via the communication channel;

(b) receiving at the first computer a request for payment from the second computer;

(c) the first person using the first computer to pass a payment instruction to a first customer's bank to effect payment to the second person;

(d) the first computer receiving a request from the first bank for identity and login information from the first person, and the first computer supplying to the first bank the identity and login information of the first person for enabling the first bank to effect a debit transaction to debit an account of the first person and to effect a corresponding payment transaction to the second person;

(e) the first's computer receiving from the first person's bank approval of both the transaction.

The present invention also provides a method for conducting an electronic transaction between a first person having a first computer and a second person having a second computer, the first and second computers being able to be connected to each other by at least one communication network, the method including the steps of:

(a) establishing a communication between the first computer and the second computer via the communication channel;

(b) sending from the second computer to the first computer a request for payment for the first person to use the first computer to pass a payment instruction to a first bank to effect payment to the second person, and for enabling the first bank to effect a debit transaction to debit an account of the first person; and

(c) the second computer receiving a corresponding payment from the first bank.

The request for payment may be passed from the second computer to the first computer via a server. Also, the first bank may pass a notification of approval of the payment to the second computer, and the first bank may effect the payment transaction to the second computer. The payment transaction may be effected via the server.

The server may collect and collate information regarding the payment transaction and the request for payment.

All communications over the communication network may be subject to security selected from the group consisting of: encryption, and SSL Protocol.

Preferably, the first computer produces a transaction information instruction in relation to the second computer. The transaction information instruction may be sent from the first computer to the first bank. Preferably, the first computer also produces a payment authorization instruction on behalf of the first person. The payment authorization instruction may be sent from the first computer to the first bank at the same time as the transaction information instruction is sent.

In response to the receipt of the transaction information instruction and the payment authorization instruction, the bank preferably produces and sends to the second computer a confirmed order and payment instruction. The confirmed order and payment instruction may contain only that information from the payment authorization instruction as is required for the second person to be able to process the payment transaction.

Preferably, authentication information and an authentication instruction is transmitted from the first computer to a certification authority to authenticate the identity of the first person; and to authenticate the transaction information instruction, or the payment authorisation instruction, or both the transaction information instruction and the payment authorisation instruction, from the first computer to the bank before processing of the transaction information instruction or the payment authorisation instruction or both the transaction information instruction and the payment authorisation instruction.

More preferably, further authentication information and a further authentication instruction is transmitted from the second computer to the certification authority to authenticate the identity of the second person; and to authenticate the confirmed order and payment instruction from the first bank to the second computer before processing of the confirmed order and payment instruction.

The confirmed order and payment instruction may be transmitted to a third computer trusted by the second person from the first bank, the confirmed order and payment instruction being sent from the first bank to the third computer; and the processed confirmed order and payment instruction may be transmitted from the third computer to the second computer.

Preferably, the transmission from the third computer to the second computer is via the server. More preferably, the transmission to the third computer form the first bank is via the server.

The first person may be a customer and the second person may be a merchant, the request for payment being as a result of an order being placed with the merchant by the customer, the order being placed by the customer using the first computer, and being received by the merchant using the second computer. The order is preferably placed by the customer as a result of the merchant supplying to the customer information about at least one product, the information passing from the second computer to the first computer. The first bank may be a bank of the customer, and the third computer may be a merchant bank computer operated by a financial institution with which the merchant establishes an account, and which also processes said confirmed order and payment instructions on the merchant's account.

The second computer may include a second component to integrate with the second person's software to implement message composition, encryption, hashing, and message sending routines. The second component may include a transaction generator that accepts messages from the second person and, depending upon the type of transaction, sends a second message to the server. The second message may be a transaction message from the second person and the second computer sends the second message to the server by redirecting the first person to the server.

The second computer may retrieve result messages sent by the server when the first computer is redirected back to the second computer after the transaction is, completed.

There may be a bank component responsible for authentication of the first person, communication with the bank's legacy systems, and to enable the bank to debit the first person for the required amount.

The server may include a transaction processor to receive redirected messages from the second computer, validate the transaction, record the transaction in a database, and to send it to the first bank.

The server may also receive status request messages from the second person regarding the status of an ongoing transaction, whereupon the server checks for the status in the database and advises the second person.

The server may further include a settlement module by which the second person can request settlement of its transactions; whereupon settlement files for a second bank of the second person are prepared and sent to the second bank to credit an account of the second person, and to, the first bank to debit the account of the first person.

### DESCRIPTION OF THE DRAWINGS

In order that the invention may be fully understood and readily put into practical effect, there shall now be described by way of non-limitative example only preferred embodiments of the present invention, the description being with reference to the accompanying illustrative drawings in which:

FIG. 1 is a representation of the system architecture;

FIG. 2 is an illustration of the system architecture of a second embodiment;

FIG. 3 is an overall flow chart for the first embodiment;

FIG. 4 is a flow chart for the merchant component for the first embodiment;

FIG. 5 is a hardware chart for the server component for the first embodiment;

FIG. 6 is a configuration chart for the web server module of the server of FIG. 5;

FIG. 7 is a hardware chart for the issuing bank for the first embodiment;

FIG. 8 is a process flow chart;

FIGS. 9(a) and (b) are flow charts for the server;

FIGS. 10(a) and (b) are flow charts for the issuing bank;

FIG. 11 is a flow chart for bank and merchant registration;

FIG. 12 is a flow chart for customer registrations; and

FIG. 13 is a flow chart for a person-to-person financial transaction.

### DESCRIPTION OF THE PREFERRED EMBODIMENTS

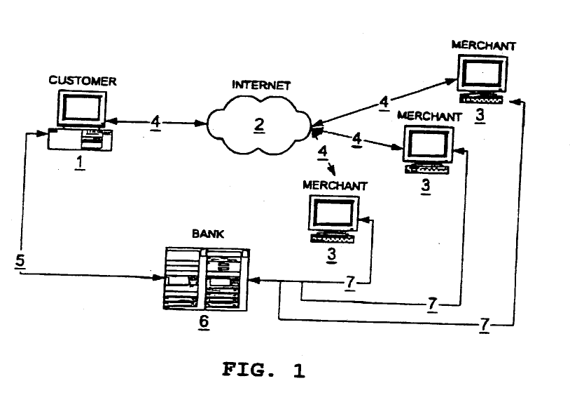

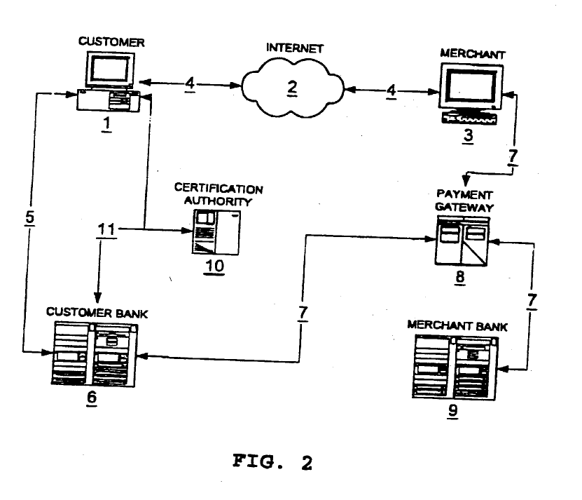

FIGS. 1, 3 and 8 depict an overview of the method of securely transmitting transaction and payment instructions between customer, merchant and customer bank. The method starts with the customer's computer 1 establishing a communication with one or more merchants' computers 3 via a communication channel such as the Internet 2. The customer's computer 1 will receive from the merchants' computers 3 information about various goods or services 4 via the Internet 2. This information about goods or services will be assembled and processed by customer's computer 1. Upon the customer confirming the purchase of the goods or services, customer's computer 1 will issue a transaction information and payment authorization instruction 5 to the customer's bank's computer 6. The customer's bank's computer will process the transaction information and payment authorisation instruction 5 and upon ascertaining the validity of the transaction information and payment authorization instruction 5, customer's bank's computer 6 will issue a confirmed order and payment instruction 7 to one or more of the merchant's computers 3.

In another embodiment of the invention, the customer's transaction instruction and payment authorization instruction and/or the customer's bank's computer's confirmed order and payment instruction may be via a payment gateway.

FIGS. 2, 3 and 8 depict an overview of a further embodiment of the method of securely transmitting transaction and payment instructions between customer, merchant and customer bank. The method starts with the customer's computer 1 establishing a communication with one or more merchants' computers 3 via a communication channel such as the Internet 2. The customer's computer 1 will receive from the merchants' computers 3 information about various goods or services 4 via the Internet 2. This information about goods or services will be assembled and processed by customer's computer 1. Upon the customer confirming the purchase of the goods or services, customer's computer 1 will issue a transaction on information and payment authorization instruction 5 to the customer's bank's computer 6. To mutually authenticate the identities of the customer and the customer's bank and to verify the authenticity of the transaction information and payment authorization instruction 5, customer's computer 1 and customer's bank's computer 6 will issue and receive authentication instructions and messages 10 from the certification authority 11. After successful authentication, the customer's bank's computer 6 will process the transaction information and payment authorisation instruction 5 and will issue a confirmed order and payment instruction 7 to a gateway computer 8 which will in turn transmit the confirmed order and payment instruction 7 to the merchant's computer 3. Through the use of the same payment gateway computer 8, the merchant's computer 3, the customer's bank's computer 6, and the merchant's bank computer will process the confirmed order and payment instruction 7.

The various entities and components that make-up the system of, and the methods used by, the present invention include:

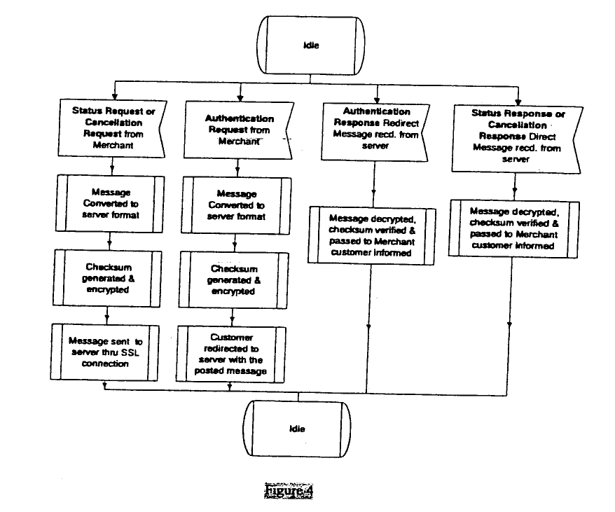

Merchant Component—FIG. 4

This will be installed at the merchant site. This component will integrate with the merchant's storefront software and will implement message composition, encryption, hashing, and message sending routines.

The merchant component includes a transaction generator. The transaction generator accepts the messages from the merchant and, depending upon the type of transaction, sends a message to the server. If it is a transaction message from the merchant, it generates a checksum, encrypts the checksum and sends the message to the server by redirecting the customer to the server. Once the transaction is completed, it receives the message from the server and sends a message to the merchant's system. If it is a status message, then a message is sent directly to the server, requesting the status of the transaction. The merchant can also generate cancellation or reversal messages. These messages are sent to the server, which in turn processes the messages and sends them to the bank.

The merchant's system retrieves the result messages sent by the server when the customer is redirected back to the merchant after the transaction is completed. An additional backup message is received directly from the server. The order is completed only after both the confirmations are received.

In the offline mode, the merchant connects to the server using its login id and password. The merchant can view all its transactions, and can request settlement of transactions. The server will settle the transactions between the customer's bank and the merchant's bank.

All transactions between the merchant and the server are preferably encrypted and sent with a checksum, using Secure Sockets Layer (SSL) communications to maintain a relatively high degree of security. The transactions take place over SSL connections, with direct connections being made over private SSLs using certificates generated by the server. This in effect creates a virtual private network between the merchant and the server.

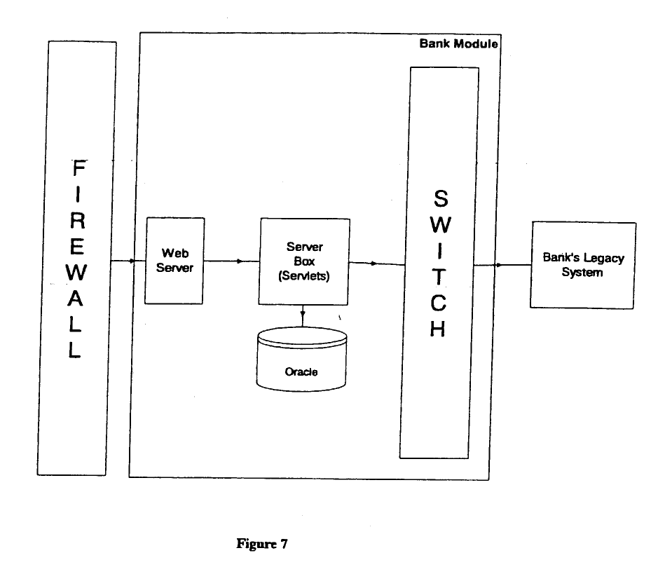

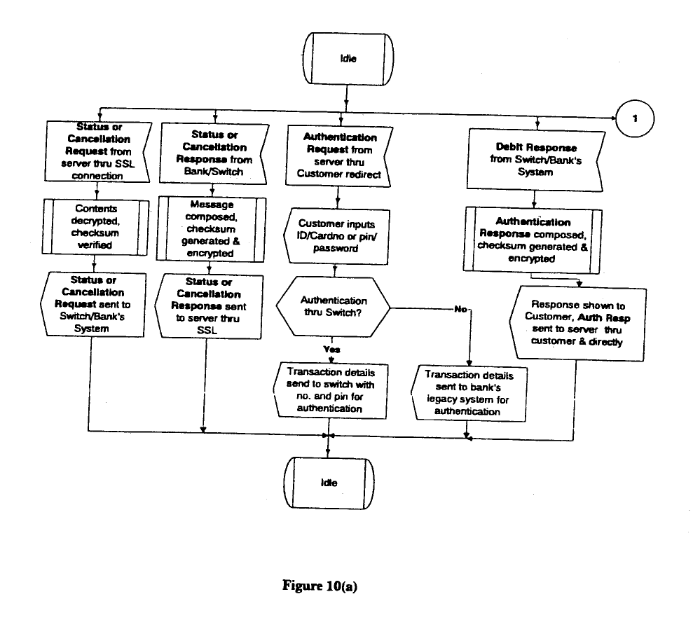

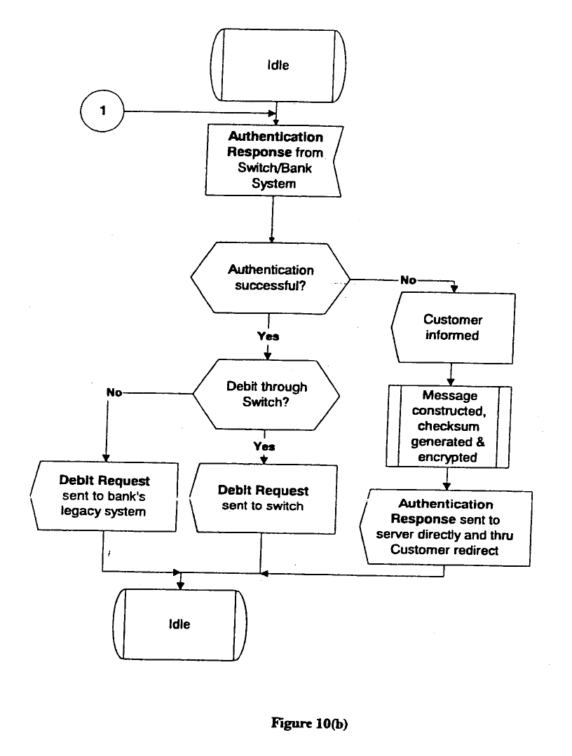

Bank Component—FIGS. 7 and 10.

The software running at the bank will be responsible for customer authentication, communicate to the bank's legacy systems, and will enable the bank to debit the customer for the required amount.

This contains the interface module and the switch interface. The interface module receives the transaction message from the server, decrypts the information, verifies the checksum, and asks the customer for their card no./account no./user ID and password/PIN. It then authenticates the customer. The authentication is done either by contacting the switch interface (which then contacts the bank for authentication) or directly by accessing the bank's systems. If the customer is authenticated, then the debit is processed, and the transaction result is sent back to the server after encryption.

The bank can accept status and cancellation messages from the server. When such a message is received, the bank interface requests the existing bank's system to reverse the transaction and reports the result back to the server.

All transactions between the bank and the server are encrypted and sent using Secure Sockets Layer (SSL) communications with a checksum to maintain a high degree of security. The transactions take place over SSL connections.

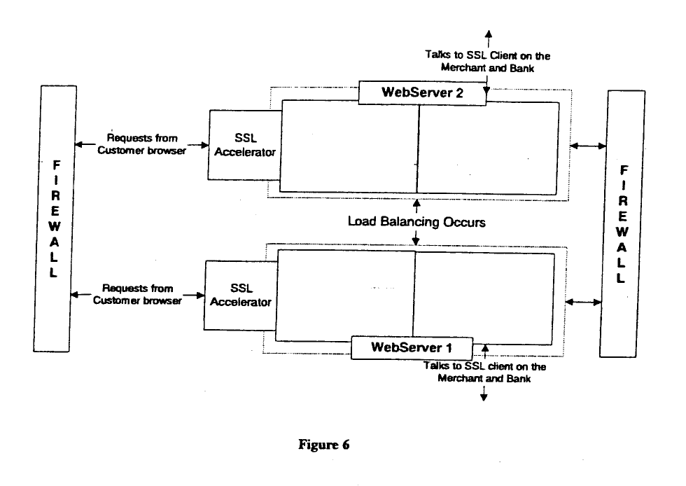

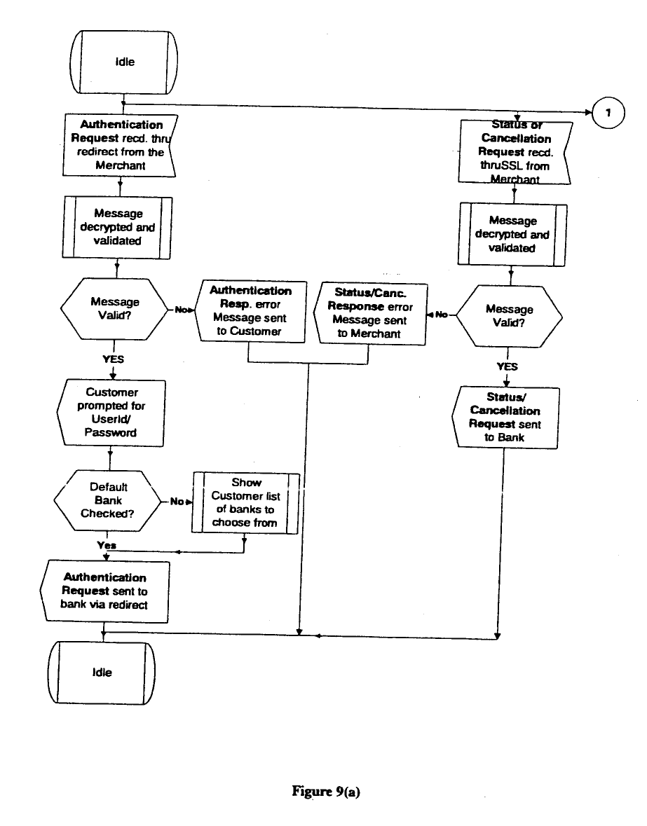

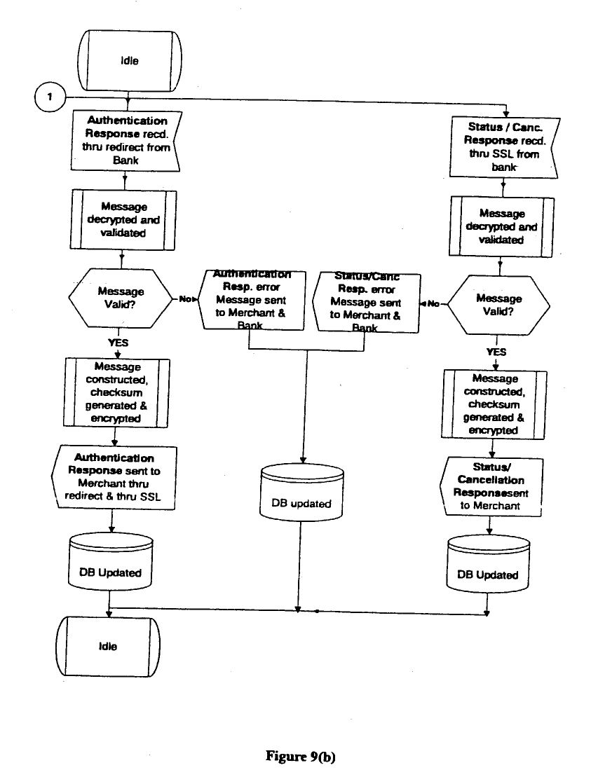

Server Component—FIGS. 5, 6 and 9.

The server will be the main element of this system. The server will be an interface between the merchant and the bank. It will enable message encryption and decryption, message construction, and maintenance of information that will be used for settlement between the merchant's bank and the bank of the customer.

The server includes a transaction processor that receives a redirected message from the merchant, decrypts it, authenticates the source, validates the transaction, and records the transaction in its database. It then asks registered customers for their user ID/password, and their bank. Unregistered users choose their country and their bank name.

The server then creates a hash total for the message, encrypts the hash total, and sends it to the customer bank. This is by redirecting the customer browser to the bank site. After the transaction is complete, the result message is received, decrypted and verified, and the result is updated in the database. The result is again encrypted and sent to the merchant by redirecting the customer back to the merchant. It also receives a backup message from the bank verifying the transaction, and sends a backup message to the merchant.

The server can receive status request messages from the merchant regarding the status of an ongoing transaction. When the server receives this message, it checks for the status in its database. If the result is not yet received, then it sends out a status request to the bank. The server will accept reversal and cancellation messages from the merchant, and reverse/cancel the transaction. These transactions are updated and then the message is forwarded to the bank for reversal/cancellation. The server will also allow the merchant to login to its system, and show the merchant the transaction history for the merchant. It will accept requests from the merchant for settlement of transactions, and will generate transaction files for settlement between the customer's banks and the merchant's bank.

The bank can also send offline messages to the server requesting for charge back/refund of a transaction for a particular user. The server will mark the transaction, and send the message to the customer's bank.

The server also provides a facility for the customer through which they can be intimated that their account has been debited and settled. This may be achieved by sending an SMS message to the customer's mobile, phone, normal, phone, facsimile machine, computer, message service, pager, or the like as requested by the customer. The relevant contact details such as, for example the customer's mobile cellular hand phone number will be captured during the registration process, and the customer will have an option to enable or disable this facility at any time. This facility will be available only to registered users.

All transactions between the server and the merchant and bank are encrypted and sent using Secure Sockets Layer (SSL) communications, with a checksum to maintain relatively a high degree of security. The transactions take place over SSL connections.

The server also includes a registration module. This module handles the registration for the three entities in the system, i.e. the customer, the merchant, and the bank.

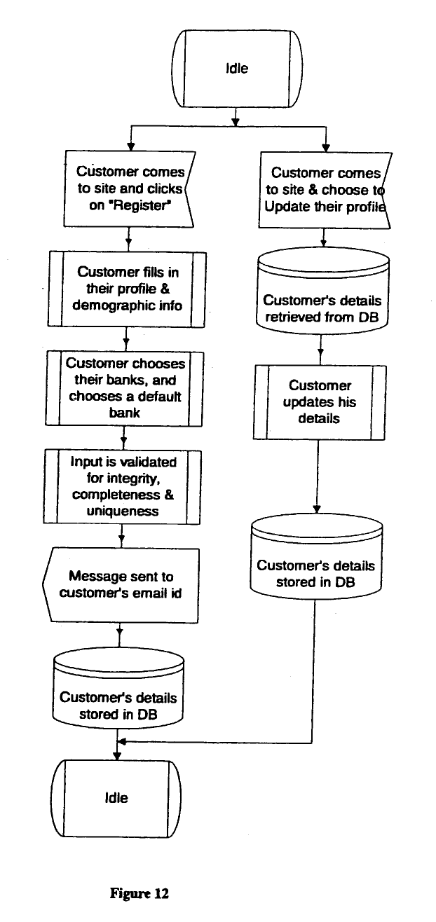

The customer registration module (FIG. 12) accepts the customer details, accepts the user ID from the customer, verifies that the user ID is not already in use, and updates the database, creates a registration number and sends an email to the customer, informing them that their account has been activated. Registered Users can then commence using their account to facilitate their purchases. The customer registration is completed over an SSL connection so that the information is not compromised.

It is not mandatory for a customer to register to avail themselves of the system. Unregistered users can also make use of the Facilities by providing details of their country and issuing bank at the time of paying for their purchase. However, registration will make it easier and faster for the customer to transact. It will also be easier for the server to target registered users for promotional purposes. Hence users will be encouraged to register. Additionally, registered users can login and view their transactions, and avail themselves of other services of included in the system.

This module will also provide standard features to enable customers to view and modify their entries, change their password, turn SMS messaging on/off, and so forth.

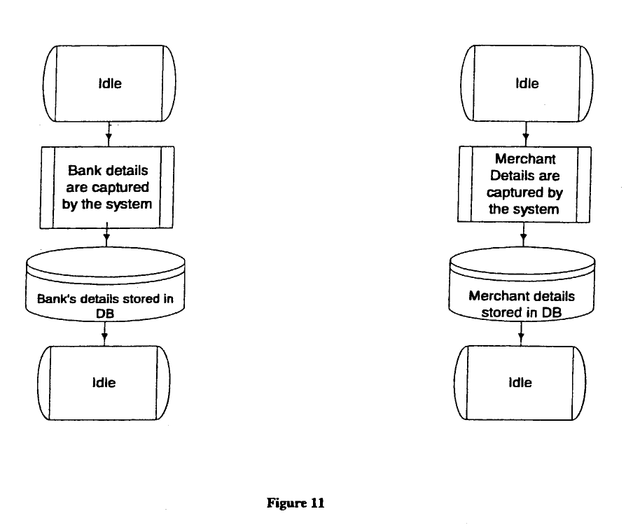

The merchant registration module (FIG. 11) accepts the merchant's details, creates a unique merchant ID, verifies that the merchant ID is not already in use, and updates the database. Once registered, the merchant can start using the services that the system provides. Typically, once registered, the necessary software will be installed and integrated on the merchant's site, and customers can then start using the system to facilitate their online transactions. Merchant registration will be offline and will be an Intranet transaction, so that the authenticity of the merchant desiring registration can be verified. The registration process will follow a maker/checker procedure where the maker will input all the details, and these will have to be authorized by the checker after verifying all the details. In addition, certain technical details like the IP address/URL/encryption keys, and so forth will have to be maintained separately by the server in another module.

Merchants can be standalone or can be a collection of individual merchants. In the latter case, an entry is created in the database for each of the merchants through the merchant registration routine, which is part of this module.

This module will also provide standard features to enable the User to view and update/modify their entries, change their password, and so forth. They can also add new merchants to their existing merchant list, or delete merchants from their list.

The bank registration module (FIG. 11) accepts the bank's details, creates a unique bank ID and updates the database. Once registered, banks can start using the services that the system provides. A server will be installed on the bank's premises, behind the bank's firewall, which will be able to communicate with the bank's legacy systems. The server of the present invention will communicate its requests to the server on the bank site, which will in turn communicate with the bank's legacy systems. Similar to the merchant registration module, this module will follow the maker/checker procedure.

The server also includes a settlement module which will operate once the transaction is complete. At the end of the day, the merchant can log on to the server and request settlement of its transactions. This module will then prepare settlement files for the merchant's bank (to indicate to the merchant's bank to credit the merchant's account), and the banks of all customers who used the merchant to make online purchases to debit their accounts. The merchants will be informed of the settlement amount offline.

These files will be integrated for all merchants arid one file will be prepared for each bank, which indicates the credit/debit for all the merchants/customers of that bank. The settlement files will be sent to the banks over a secure connection.

This module will handle all charge back/refund requests from the bank or the merchant.

The firewalls are intended to restrict unauthorized entry into the system. External users will be able to send requests to the server Preferably only through HTTP and HTTPS protocols. The incoming traffic on HTTP and HTTPS protocols will be routed to a load balancer.

The second firewall preferably accepts requests only from Web Servers, and will forward the requests only to the application server. Physically, the two firewalls may be in the same machine. The firewall may be a hardware device.

The load balancer may be a device which accept traffic from the firewall and route it to different servers. This will distribute the traffic across different web servers.

The web servers will receive requests from the load balancer and process them using servlets/JSP technology. There may be a number of machines hosting the web server and the load balancer may distribute requests between them. Each web server machine may have two web servers running: one to cater to customer requests; and a second to communicate only with the merchant and the bank using SSL for sending direct messages.

The server may be a Certification Authority and may issue Certificates to the bank and the merchant. One certificate will be generated for each bank and each merchant that registers.

This system may use a SSL accelerator. It may be a hardware device that handles SSL connections for the web servers. SSL connections are time consuming to create and to tear down. This device may speed-up the process and reducing the processing required of the web server.

The switch at the bank acts as an interface between the server message module and legacy bank system for processing of transaction. It is, basically, a transaction engine which can handle high transaction volumes, and different kinds of message structures.

As the system will handle financial transactions of an extremely sensitive nature, and which flow through the Internet and not through a private network, security is important. Preferably, all transactions which take place on line (i.e., from the merchant to the server and vice versa, from the server to the bank and vice versa) will take place over SSL (secure socket layer) connections using, for example, 128-bit encryption/40-bit encryption. In addition to using SSL, all messages before being sent out on the Internet may be hashed to generate a checksum. This checksum will be encrypted using public key/private key infrastructure. This encrypted checksum may be appended to the end of the message before being sent out over the Internet.

Furthermore, digital certificates may be maintained at each of the three sites, the merchant, the server and the bank. There may be two types of digital certificates:

a certificate issued by an independent Certifying Authority, such as “Verisign”. (trade mark), will be maintained by all the three entities. This will be used when the merchant and the server exchange messages using the customer's browser as an intermediary, and also when the server sends direct messages to the bank or the merchant; and

the server may be a Certifying Authority. It may issue digital certificates to the merchant and to the bank. These certificates will be used for authentication when the bank or merchant communicates with the server directly (i.e., without using the customer's browser to redirect).

Passwords may be stored on the database using Secret Key Encryption.

A mail server may be used at the server to communicate with customers. Merchants and banks may also be sent e-mail messages regarding administrative procedures and maintenance through the mail server.

The security management system is used to authenticate the user. It may also be used to authenticate an internal user, their role, and entitlements. It may also be used to authenticate external users from the banks and merchants.

To now refer to FIG. 12, there is illustrated a customer registration procedure. The customer goes to the server's web site, and selects the “register” option They then complete the profile fields, and provide details of their banks, a default bank, and the relevant accounts. After checking for completeness, the details are confirmed to the customer by e-mail, and stored in the server's database.

If a customer wishes to update their profile, after login the details are retrieved from the database and changed by the customer. They are then stored in the database. There may be a confirmation to the customer by e-mail, if desired.

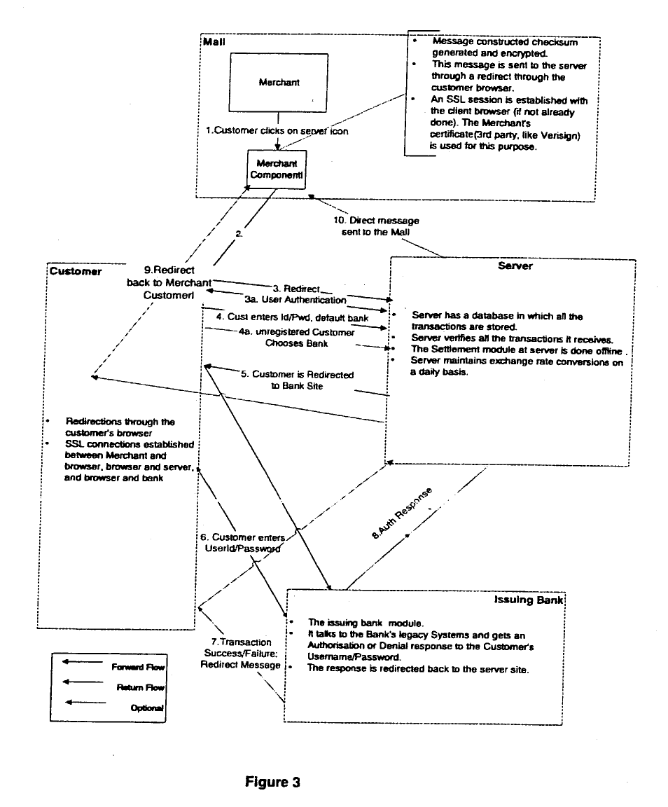

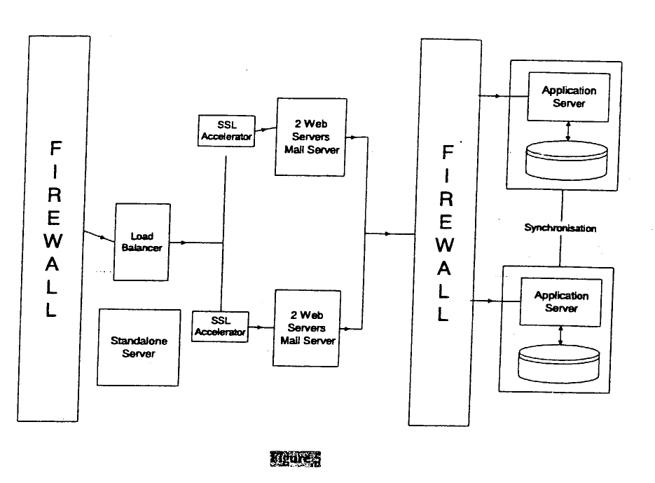

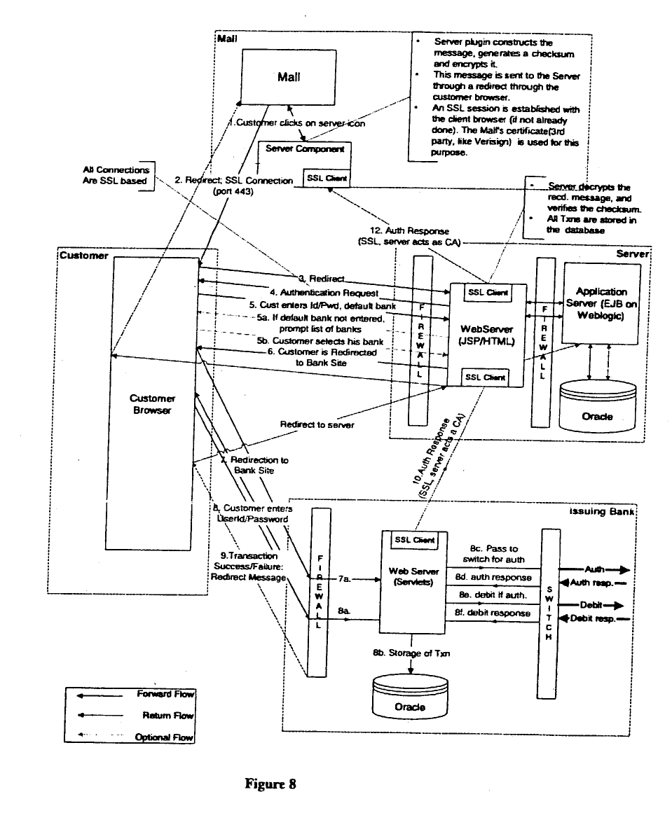

To now refer to FIGS. 3 and 8, when the customer goes online to the merchant and purchases a few items, they have to pay for the purchases. They can therefore click on the link to the server which is provided as one of the payment options on the merchant's page. This may be by an icon. The data from the customer's shopping cart is transferred to the merchant's end. The merchant's module constructs a message in a format (e.g. XML) that the server will understand. A checksum for the message is generated and the checksum is encrypted.

An SSL connection is established with the browser (if not already done so), and the data is sent to the server by being redirected through the customer's browser. An SSL connection is also established with the server at this time.

The customer enters their login id and password, and selects their default bank. The server smaller group verifies the login id and password, and reconstructs the message, which needs to be sent to the bank. It generates a checksum for the message and encrypts the checksum. The system then redirects the customer to their issuing bank.

Non-registered users can select their issuing bank from a list of banks which have registered. They are then redirected to the bank site in the same manner as for registered users.

At the customer's bank site, the customer is asked for their user name and password, card number and pin. The message received from the server is decrypted and all information validated.

In parallel, the account information entered by the customer is validated by the bank system. This validation may be by passing the message to the switch interface (which then “talks” to the bank's legacy system) or by the system's module at the bank “staking” directly to the bank's systems. This will depend on how the bank's systems function.

If validation is successful, the customer's account is debited by the amount as specified in the message received from the server, which also specifies the currency for debit The debit is made through the switch or directly by the system “talking” to the bank's system.

The transaction is now complete. The customer is informed that their account has been debited, and the customer is redirected back to the server site. A message is sent with the redirect informing the server about the success of the transaction. An additional message is sent directly from the bank to the server. This message is intended as a backup of the original (redirect) message.

Settlement is done offline at the end of the day. The merchant requests the server for settlement. The server generates the settlement files for the merchant's bank and the customer's bank and informs its bank—the server's bank which acts as a settlement bank for the customer's and the merchant's banks. To settle the accounts.

The merchant's bank pays the merchant and the customer's bank confirms to the customer (in a monthly statement or bill) that the debit was successful.

The customer may cancel their order at the merchant's site using the order number provided by the merchant. The merchant's module generates a cancellation for that particular order and sends it to the server. The server receives the cancellation, verifies the transaction details and cancels the transaction. The merchant can also decide to cancel the order of its own accord (if it is unable to meet the order, for example).

The customer can demand a refund from the bank (for example, if the customer claims they did not purchase the goods or receive the service as claimed by the merchant). The bank then requests a charge back from the merchant's bank through the server. The server processes this request and generates a file for the merchant's bank.

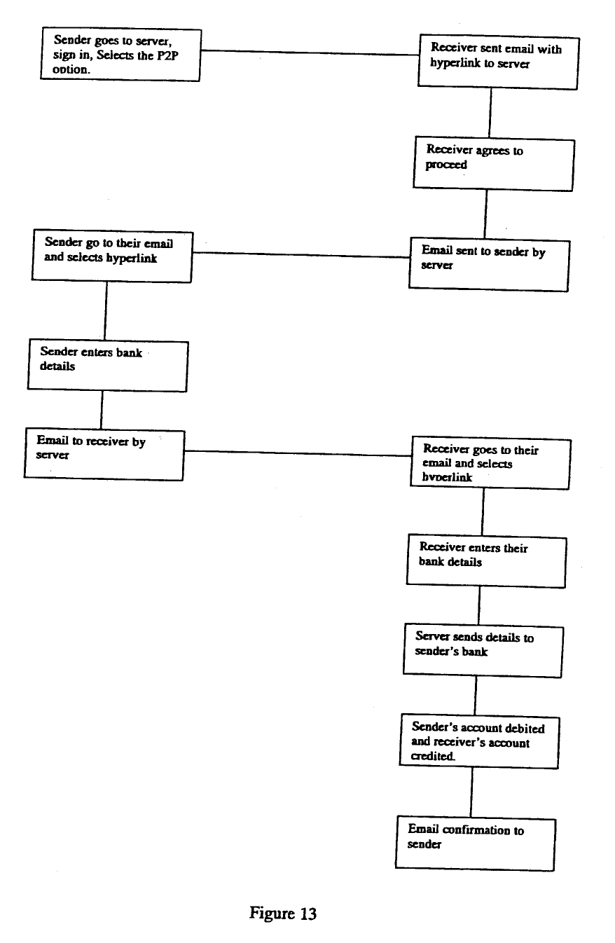

FIG. 13 illustrates a person-to-person transaction, which would be available to registered users only. Here, the sender logs in to the server, and selects the person-to-person option. Details of the receiver are entered. The receiver is sent an e-mail by the server, the e-mail having a hyperlink to the server. If the receiver is not a registered user of the system, they will not be required to be registered, but may be encouraged to do so. Details of the intended payment are given to the receiver, and they are asked to confirm their intention to proceed. If “yes”, the server sends an e-mail to the sender indicating that the receiver intends to proceed. The e-mail contains a hyperlink. The sender selects the hyperlink, enters their login details, bank detals (if not the default bank), and the server sends to the receiver an e-mail requesting details of the account to be credited. Upon receipt of the information from the receiver, the sender's account is debited and the receiver's account credited. A confirmation is sent to the sender, and may be sent to the receiver, if desired.

The server will handle currency conversion between the merchants and the banks. All transactions that are received from the merchant are converted either to a single currency or to the Issuing bank's local currency. The currency in which a particular bank deals is stored during the registration of the bank. The daily exchange rates will be maintained on the server. Registered users may check their transaction history and update their profile. Registered users may be able check their transaction history and update their profile, if desired.

Whilst there has been described in the foregoing description preferred embodiments of the present invention, it will be understood by those skilled in the technology that many variations on modification in details of operation on methodology may be made without departing from the present invention.

1. A method for conducting an electronic transaction between a first person having a first computer and a second person having a second computer, the first and second computers being able to be connected to each other by at least one communication network, the method including the steps of:
(a) establishing a communication between the first computer and the second computer via the communication channel;
(b) receiving at the first computer a request for payment from the second computer;
(c) the first person using the first computer to pass a payment instruction to a first bank to effect payment to the second person;
(d) the first computer receiving a request from the first bank for identity and login information from the first person, and the first person using the first computer for supplying to the first bank the identity and login information of the fist person for enabling the first bank to effect a debit transaction to debit an account of the first person and to effect a corresponding payment transaction to the second person; and
(e) the first computer receiving from the first bank approval of both transactions.

2. A method for conducting an electronic transaction between a first person having a first computer and a second person having a second computer, the first and second computers being able to be connected to each other by at least one communication network, the method including the steps of:
(a) establishing a communication between the first computer and the second computer via the communication channel;
(b) sending from the second computer to the first computer a request for payment for the first person to use the first computer to pass a payment instruction to a first bank to effect payment to the second person, and for enabling the first bank to effect a debit transaction to debit an account of the first person; and
(c) the second computer receiving a corresponding payment from the first bank.

3. A method as claimed in claim 1 and claim 2, wherein the request for payment is passed from the second computer to the first computer via a server.

4. A method as claimed in any one of claims 1 to 3, wherein the first bank passes a notification of approval of the payment to the second computer.

5. A method as claimed in claim 3 or claim 4, wherein the first bank effects the payment transaction to the second computer.

6. A method as claimed in claim 5, wherein the payment transaction is effected via the server.

7. A method as claimed in claim 3 or claim 6, wherein the server collects and collates information regarding the payment transaction and the request for payment.

8. A method as claimed in any one of claims 1 to 7, wherein all communications was the communication network are subject to security selected from the group consisting of: encryption and SSL Protocol.

9. A method as claimed in any one of claim 1 to 8, wherein the first computer produces a transaction information instruction in relation to the second computer.

10. A method as claimed in claim 9, wherein the transaction information instruction is sent from the first computer to the first bank

11. A method as claimed in claim 10, wherein the first computer also produces a payment authorization instruction on behalf of the first person.

12. A method as claimed in claim 11, wherein the payment authorization instruction is sent from the first computer to the first bank at the same time as the transaction information instruction is sent.

13. A method as claimed in claim 12, wherein in response to the receipt of the transaction information instruction and the payment authorization instruction, the bank produces and sends to the second computer a confirmed order and payment instruction.

14. A method as claimed in claim 13, wherein the confirmed order and payment instruction contains only that information from the payment authorization instruction as is required for the second person to be able to process the payment transaction.

15. A method as recited in any one of claims 1 to 14, including transmitting authentication information and an authentication instruction from the first computer to a certification authority to authenticate the identity of the first person; and to authenticate the transaction information instruction, or the payment authorisation instruction, or both the transaction information instruction and the payment authorisation instruction, from the first computer to the first bank before processing of the transaction information instruction or the payment authorisation instruction or both the transaction information instruction and the payment authorisation instruction.

16. A method as recited in any one of claims 1 to 15 including transmitting authentication information and an authentication instruction from the first bank to a certification authority to authenticate the identity of the first bank; and to authenticate the transaction information instruction, or the payment authorisation instruction, or both the transaction information instruction and the payment authorisation instruction, from the first computer to the first bank before processing of the transaction information instruction or the payment authorisation instruction or both the transaction information instruction and the payment authorisation instruction.

17. A method as claimed in claim 15 or claim 16, including transmitting further authentication information and a farther authentication instruction from the second computer to the certification authority, to authenticate the identity of the second person and to authenticate the confirmed order and payment instruction from the first bank to the second computer before processing of the confirmed order and payment instruction.

18. A method as claimed in any one of claims 13 to 17, wherein the confirmed order and payment instruction is transmitted to a third computer trusted by the second person from the first bank, the confirmed order and payment instruction is sent from the first bank to the third computer; and the processed confirmed order and payment instruction is transmitted from the third computer to the second computer.

19. A method as claimed in claim 18, wherein the transmission from the third computer to the second computer is via the server.

20. A method as claimed in claim 18 or 19, wherein the transmission to the third computer from the first bank is via the server.

21. A method as claimed in any one of claims 1 to 20, wherein the second computer includes a second component to integrate with the second person's software to implement message composition, encryption, hashing, and message sending routines.

22. A method as claimed in claim 21, wherein the second component includes a transaction generator that accepts messages from the second person and, depending upon the type of transaction, sends a second message to the server.

23. A method as claimed in claim 22, wherein the second message is a transaction message from the second person and the second computer sends the second message to the server by redirecting the first person to the server.

24. A method as claimed in claim 22 or claim 23, wherein the second computer retrieves result messages sent by the server when the first computer is redirected back to the second computer after the transaction is completed.

25. A method as claimed in any one of claims 1 to 24, wherein there is a bank component responsible for authentication of the first person, communication with the bank's legacy systems, and to enable the bank to debit the first person for the required amount.

26. A method as claimed in any one of claims 1 to 24, wherein the server includes a transaction processor to receive redirected messages from the second computer, validate the transaction, record the transaction in a database, and to send it to the first bank.

27. A method as claimed in claim 26, wherein the server receives status request messages from the second person regarding the status of an ongoing transaction, in response to which the server checks for the status in the database and advises the second person.

28. A method as claimed in claim 26 or claim 27, wherein the server also includes a settlement module by which the second person can request settlement of its transactions; whereupon the server prepares settlement files for a second bank of the second person and sends them to the second bank to credit an account of the second person, and to the first bank to debit the account of the first person.

29. A method for conducting an electronic transaction between a first person having a first computer and a second person having a second computer, the first and second computers being able to be connected to each other by at least one communication network via a server, the method including the steps of:
(a) the server receiving a communication from the first computer via the comunication channel, the communication containing a request for payment to the second person;
(b) the server advising the second computer of the request for payment and requesting details of the second person's bank;
(c) the server receiving the first person using the first computer a payment instruction to effect payment to the second person;
(d) conveying to the first person a request from a first bank for identity and login information from the first person, to enable the first person to use the first computer for supplying to the first bank the identity and login information of the first person thus enabling the first bank to effect a debit transaction to debit an account of the first person and to effect a corresponding payment transaction to the second person; and
(e) sending to the first computer advice of completing of the transactions.

30. A method as claimed in claim 29, wherein the server receives bank account details from the second person before proceeding with step (c).

31. A method as claimed in any one of claims 1 to 30, wherein the first person is a customer and the second person is a merchant, the request for payment being as a result of an order being placed with the merchant by the customer, the order being placed by the customer using the first computer, and being received by the merchant using the second computer.

32. A method as claimed in claim 31, wherein the order is placed by the customer as a result of the merchant supplying to the customer information about at least one product, the information passing from the second computer to the first computer.

33. A method as claimed in claim 31 or claim 32, wherein the first bank is a bank of the customer.

34. A method as claimed in any one of claims 31 to 33, wherein the second bank is a bank of the merchant.

35. A method as claimed in any one of claims 31 to 32, wherein the third computer is a merchant bank computer operated by a financial institution with which the merchant establishes an account and which also processes said confirmed order and payment instructions on the merchant's account.

36. A computer readable medium including a series of program instructions for performing the method of any one of claims 1 to 35.
